(19) United States
(12) Patent Application Publication
(10) Pub. No.: US 2021/0168343 A1
(43) Pub. Date: Jun. 3, 2021

(54) CONTROL METHOD FOR PROJECTOR AND PROJECTOR

(71) Applicant: SEIKO EPSON CORPORATION, Tokyo (JP)

(72) Inventor: Koki SHIGA, Matsumoto-shi (JP)

(21) Appl. No.: 17/104,651

(22) Filed: Nov. 25, 2020

(30) Foreign Application Priority Data
Nov. 28, 2019 (JP) 2019-215066

(51) Int. Cl. H04N 9/31; G06K 9/00; H04N 9/78

(52) U.S. Cl. CPC H04N 9/3194; H04N 9/78; G06K 9/00664; H04N 9/3185

(57) ABSTRACT

An image is projected onto a projection surface. Image data is acquired from an image sensor having a visual field including the image. A type of an object included in the visual field is specified based on the image data. A region where the object overlaps the image in the image data is determined according to the type. Luminance of the image in a range corresponding to the region is selectively reduced.

The present application is based on, and claims priority from JP Application Serial Number 2019-215066, filed Nov. 28, 2019, the disclosure of which is hereby incorporated by reference herein in its entirety.

### BACKGROUND

### 1. Technical Field

The present disclosure relates to a control method for a projector and the projector.

### 2. Related Art

JP-A-2008-250242 (Patent Literature 1) discloses a projector that detects the distance to an object with an object detection sensor and reduces the luminance of irradiated light when the detected distance is equal to or smaller than a shortest focal distance.

However, in the technique described in Patent Literature 1, it is likely that visibility of an image is unnecessarily deteriorated because the illuminance of the irradiate light is uniformly reduced irrespective of a type of the object when the distance to the object is equal to or smaller than the shortest focal distance.

### SUMMARY

An aspect is directed to a control method for a projector, including: projecting an image onto a projection surface; acquiring image data from an image sensor having a visual field including the image; specifying, based on the image data, a type of an object included in the visual field; determining, according to the type, a region where the object overlaps the image in the image data; and selectively reducing luminance of the image in a range corresponding to the region.

Another aspect is directed to a projector including: a projection device configured to project an image onto a projection surface; an image sensor having a visual field including the image; a type specifying section configured to specify, based on image data acquired from the image sensor, a type of an object included in the visual field; a region determining section configured to determine, according to the type, a region where the object overlaps the image in the image data; and a control section configured to control the projection device to selectively reduce luminance of the image in a range corresponding to the region.

### BRIEF DESCRIPTION OF THE DRAWINGS

FIG. 1 is a diagram for explaining a projector according to an embodiment.

FIG. 2 is a block diagram for explaining a basic configuration of the projector according to the embodiment.

FIG. 3 is a diagram for explaining processing for detecting an object region.

FIG. 4 is a diagram for explaining processing for determining a superimposition region.

FIG. 5 is a diagram for explaining processing for specifying types of a plurality of objects.

FIG. 6 is a diagram for explaining processing for specifying a face as a type of an object.

FIG. 7 is a diagram for explaining processing for specifying eyes as a type of an object.

FIG. 8 is a flowchart for explaining the operation of the projector according to the embodiment.

FIG. 9 is a block diagram for explaining a basic configuration of a projector according to another embodiment.

### DESCRIPTION OF EXEMPLARY EMBODIMENTS

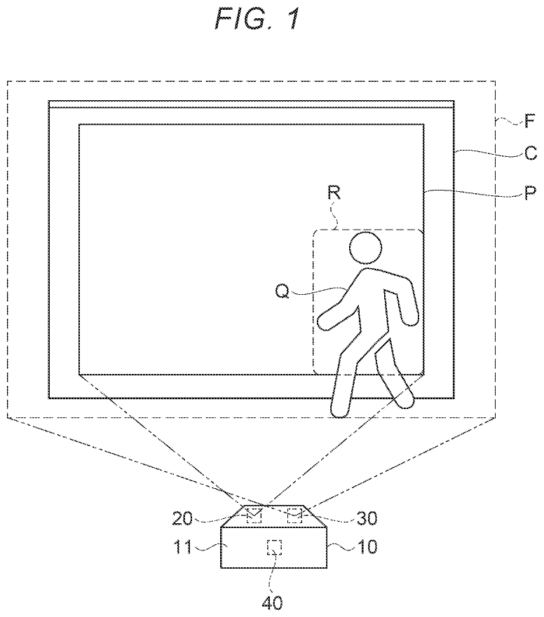

An embodiment of the present disclosure is explained below with reference to the drawings. As shown in FIG. 1, a projector 10 according to the embodiment includes a projection device 20 that projects an image P onto a projection surface C, an image sensor 30 having a visual field F including the image P, and a control circuit 40 that controls each of the projection device 20 and the image sensor 30. As the projection surface C, for example, various screens such as a roll screen, a whiteboard, and a wail surface can be adopted. In an example shown in FIG. 1, an object Q, which is a human, is located in a projection range of the image P.

The projection device 20 includes, for example, a light source such as a discharge lamp or a solid-state light source, a display element such as a liquid crystal light valve including a plurality of pixels, and an optical system including a mirror and a lens. The display element modulates, according to the control by the control circuit 40, light emitted from the light source. The projection device 20 projects the light modulated by the display element onto the projection surface C as the image P using the optical system. Besides, as a scheme of the projection device 20, a scheme for using a mirror device that scans the projection surface C with the modulated light and a scheme for using a digital micro mirror device that controls reflection of the light in each of the pixels can be adopted.

The image sensor 30 includes a solid-state imaging element and an optical system that introduces light in the visual field F into the solid-state imaging element. That is, the position and the orientation of the image sensor 30 are adjusted such that a projection range of the image P is included in the visual field F. More specifically, the visual field F is determined as a range wider than the image P on the projection surface C. Accordingly, the position and the orientation of the image sensor 30 with respect to the projection device 20 can be easily adjusted. The image sensor 30 successively generates image data representing an image corresponding to the visual field F with the solid-state imaging element and outputs the image data to the control circuit 40. In the example shown in FIG. 1, the projection device 20, the image sensor 30, and the control circuit 40 are disposed on the inner side of a housing 11 of the projector 10. However, for example, the image sensor 30 may be disposed on the outer side of the housing 11.

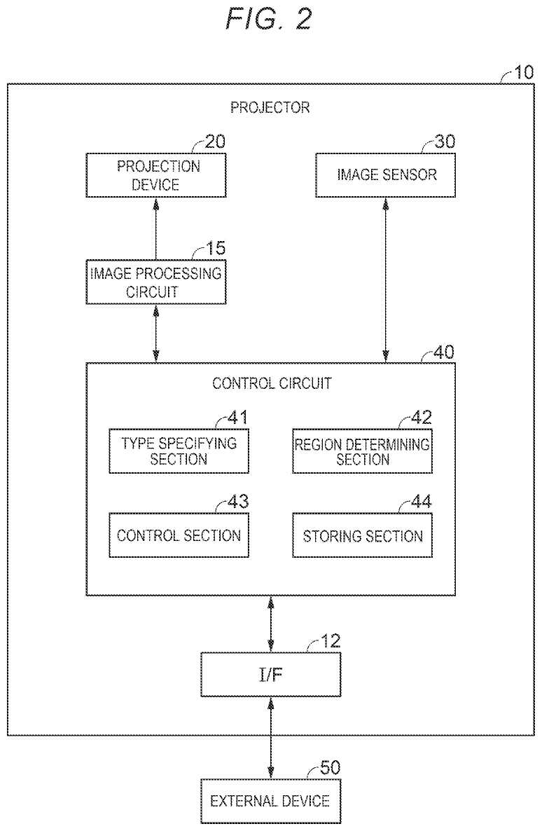

As shown in FIG. 2, the projector 10 further includes an interface (I/F) 12 and an image processing circuit 15. For example, a video signal is input to the I/F 12 from an external device 50 via a communication link between the I/F 12 and the external device 50. The external device 50 is any device having a function of outputting a video signal to the projector 10. The communication link between the I/F 12 and the external device 50 may be either a wired communication link or a wireless communication link and may be a combination of the wired and. wireless communication links. The I/F 12 can include, for example, an antenna that transmits and receives radio signals, a receptacle into which a plug for a communication cable is inserted, and a communication circuit that processes a signal transmitted in the communication link.

The image processing circuit 15 generates, according to the control by the control circuit 40, an image signal representing the image P projected from the projection surface C. Specifically, the image processing circuit 15 generates an image signal based on a video signal input to the I/F 12 from the external device 50 and outputs the image signal to the projection device 20. The image processing circuit 15 may generate, based on computer graphics generated by a control program of the control circuit 40, the image signal representing the image P. The image processing circuit 15 outputs successively generated image signals to the projection device 20. The image processing, circuit 15 includes a rendering, engine and a graphics memory. The image processing circuit 15 may function as a circuit configuring a part of the control circuit 40.

The control circuit 40 includes a type specifying section 41, a region determining section 42, a control section 43, and a storing section 44 as logical structure. The control circuit 40 is configured by, for example, a single or a plurality of processors. As an example, the control circuit 40 is configured by a single or a plurality of central processing units (CPUs). A part or all of functions of the control circuit 40 may be configured by a circuit such as a DSP (Digital Signal Processor), an ASIC (Application Specific Integrated Circuit), a PLD (Programmable Logic Device), or an FPGA (Field Programmable Gate Array). The control circuit 40 configures a computer system that processes an arithmetic operation necessary for the operation of the projector 10. For example, the control circuit 40 executes a preinstalled control program to thereby realize functions described in the embodiment besides the type specifying section 41, the region determining section 42, the control section 43, and the storing section 44.

The storing section 44 is, for example, a computer-readable storage medium that stores a control program, various data, and the like necessary for the operation of the control circuit 40. The storing section 44 includes, for example, a semiconductor memory. The storing section 44 can include a nonvolatile auxiliary storage device, a volatile main storage device such as a register or a cash memory incorporated in the CPU. The control circuit 40 may be configured from integral hardware or may be configured from a separate plurality of kinds of hardware.

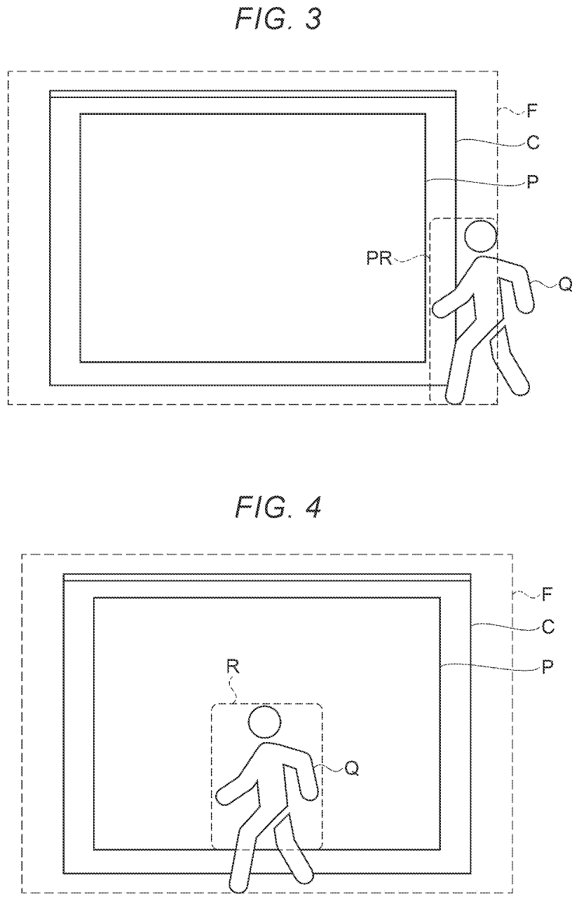

As shown in FIG. 3, the type specifying section 41 successively specifies, based on image data acquired from the image sensor 30, a type of the object Q included in the visual field F. For example, the type specifying section 41 specifies a type of the object Q using a learned model generated by machine learning. As the learned model, various object detection algorithms such as an SSD (Single Shot MultiBox Detector) and a YOLO (You Only Look Once) can be adopted. The type of the object Q specified by the type specifying section 41 is at least one type selected out of, for example, a human, a part of the body of the human, an animal, and a vehicle. The type specifying section 41 can highly accurately specify a type of the object Q by using the learned model. By changing the learned model, the type specifying section 41 can select a type of the object Q to be specified.

In an example shown in FIG. 3, the type specifying section 41 specifies a type of the object Q present outside the image P in image data of the visual field F as a human and successively detects an object region PR, which is a region where the object Q is present in the image data. The object region PR is detected as a region corresponding to the position and the size of the object Q in the image data. The object region PR is, for example, a rectangular region occupied by the object Q in the image data. The type specifying section 41 racks the object Q in the image data to thereby cause the object region PR to follow the object Q. By selectively specifying a type of the object Q present outside the image P the image data and tracking the object Q, it is easy to distinguish an actual object Q present in the visual field a from an object projected as the image P.

As shown in FIG. 4, the region determining section 42 successively determines, according to the type of the object Q specified by the type specifying section 41, a superimposition region R, which is a region where the object Q overlaps the image P in the image data. The superimposition region R is, for example, a rectangular region occupied by the object Q in the image P in the image data A region of the image P in the image data can be defined advance by a projection range or the like by the projection device 20. Accordingly, the image P does not need to be actually projected at a point in time when the region determining section 42 determines the superimposition region R. Alternatively, the region determining section 42 may recognize the region of the image P in the image data based on a pattern image projected by the projection device 20. The region determining section 42 calculates a region where the object region PR overlaps the image P in the image data and determines the region as the superimposition region R.

The control section 43 indirectly controls the projection device 20 via the image processing circuit 15 to selectively reduce the luminance of the image P in a range corresponding to the superimposition region R. Specifically, the control section 43 converts the superimposition region R in the image data into a corresponding region in an image signal and outputs the image signal to the image processing circuit 15. For example, the image processing circuit 15 changes a color tone of the corresponding region with respect to an image signal generated based on a video signal of the external device 50 and then outputs the image signal to the projection device 20. The projection device 20 projects the image P onto the projection surface C according to the image signal input from the image processing circuit 15. Consequently, the control section 43 selectively reduces the intensity of light projected by the projection device 20 in a range corresponding to the object Q of a predetermined type. Therefore, it is possible to suppress visibility of the image P from being unnecessarily deteriorated.

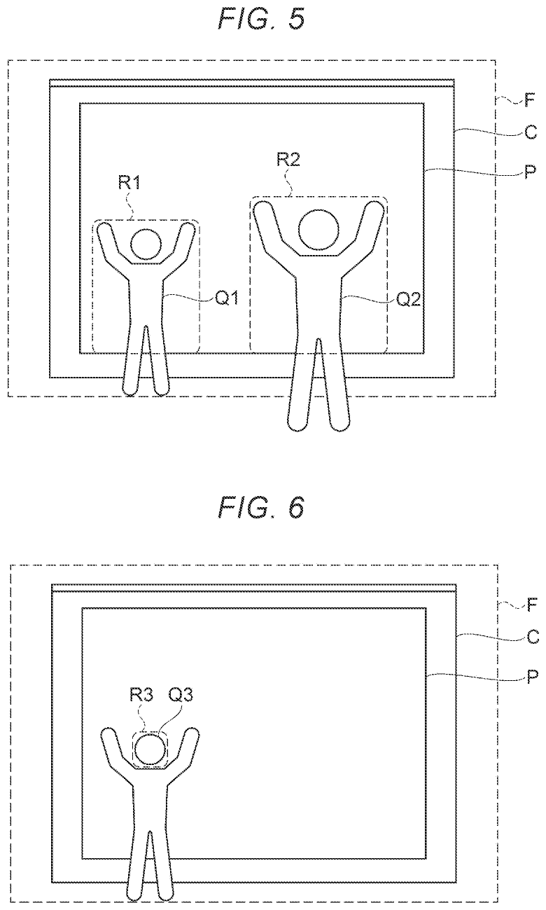

As shown in FIG. 5, the type specifying section 41 may specify a type of each of a plurality of objects Q1 and Q2 included in the visual field F. In an example shown in FIG. 5, the type specifying section 41 specifies types of two objects Q1 and Q2 respectively as humans based on image data corresponding to the visual field F. The region determining section 42 determines a superimposition region R1 where the object Q1 overlaps the image P in the image data and a super imposition region R2 where the object Q2 overlaps the image P in the image data. The control section 43 controls the projection device 20 to selectively reduce the luminance of the image P in regions corresponding to the two superimposition regions R1 and R2.

As shown in FIG. 6, the type specifying section 41 may specify a face of a human as a type of an object Q3 in image data. In this case, as the learned model of the type specifying section 41, face recognition algorithms such as DenseBox and UnitBox can be adopted. The region determining section 42 determines a super imposition region R3, which is a region where a rectangular region occupied by the face of the human overlaps the image P in the image data. The control section 43 controls the projection device 20 to selectively reduce the luminance of the image P in a range corresponding to the superimposition region R3.

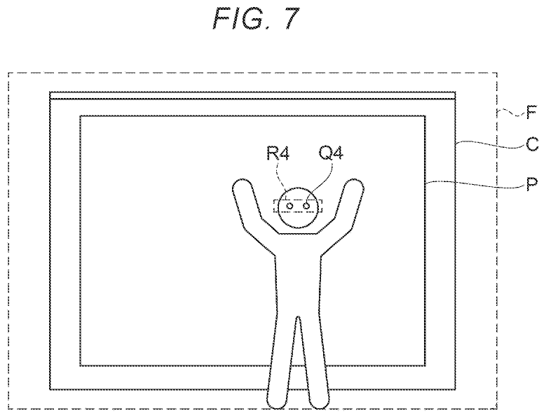

Alternatively, as shown in FIG. 7, the type specifying section 41 may specify eyes of a human as a type of an object Q4 in image data. For example, the type specifying section 41 detects an object region including the eyes of the human in the image data. The region determining section 42 determine a super imposition region R4 where the object region overlaps the image P in the image data. The control section 43 controls the projection device 20 to selectively reduce the luminance of the image P in a range corresponding to the superimposition region R4. Consequently, a range in which the luminance of the image P is reduced on the projection surface C can be further limited. Therefore, it is possible to further suppress deterioration in the visibility of the image P. Since the type specifying section 41 specifies the face or the eyes of the human as the type of the object Q, it is possible to suppress glare from being given to a human located between the projection device 20 and the projection surface C.

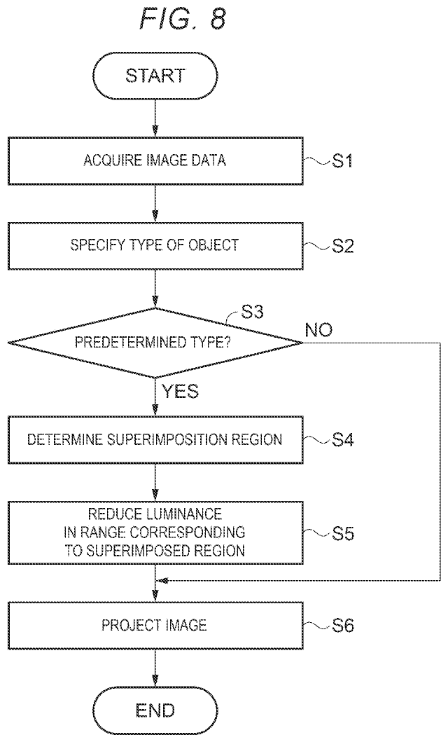

An example of the operation of the projector 10 is explained below as a control method for the projector 10 according to the embodiment with reference to a flowchart of FIG. 8. For example, the projector 10 acquires a video signal from the external device 50 to thereby project the image P onto the projection surface C. A series of processing shown in FIG. 8 is repeatedly executed at a predetermined sampling period.

In step S1, the type specifying section 41 acquires image data of the visual field F from the image sensor 30 having the visual field F. In step S2, the type specifying section 41 specifies, based on the image data acquired in step S1, a type of the object Q present in the field F. The type specifying section 41 detects the object region PR, which is a region where the object Q is present in the image data. In step S3, the type specifying section 41 determines whether the type of the object Q specified in step S2 is a predetermined type, that is, whether the object Q of the predetermined type is detected in the image data. The predetermined type is at least one type selected out of, for example, a human, a part of the body of the human, an animal, and a vehicle, when the type of the object Q is the predetermined type, the type specifying section 41 advances the processing to step S4. When the type of the object Q is not the predetermined type, the type specifying section 41 advances the processing to step S6.

In step S4, the region determining section 42 determines, according to the type of the object Q specified in step S2, the superimposition region R where the object region PR overlaps the image P in the image data. In step S5, the control section 43 controls the projection device 20 via the image processing circuit 15 to selectively reduce the luminance of the image P in a range corresponding to the superimposition region R determined in step S4. That is, the image processing circuit 15 changes, according to the control by the control section 43, an image signal such that the luminance of the image P in the range corresponding to the superimposition region R is selectively reduced and outputs the image signal to the projection device 20. In step S6, the projection device 20 projects the image P onto the projection surface C according to the image signal input from the image processing circuit 15. Consequently, the luminance of the image P on the projection surface C is selectively reduced in the range corresponding to the superimposition region R, that is, the region where the object Q is present.

With the projector 10 according to the embodiment, the projection device 20 is controlled according to the type of the object Q to selectively reduce the luminance of the image P in the range corresponding to the object Q. Therefore, it is possible to suppress visibility of the image P from being unnecessarily deteriorated.

The embodiment is explained above. However, the present disclosure is not limited to the disclosure of the embodiment. The components of the sections may be replaced with any components having the same functions. Any components in the embodiment may be omitted or added within the technical scope of the present disclosure. In this way, various alternative embodiments are made clear for those skilled in the art from the disclosure of the embodiment.

For example, in the embodiment explained above, the type specifying section 41 may update the learned model with information acquired from the outside of the projector 10. In this case, the control circuit 40 can include a programmable logic device (PLD) such as a field programmable gate array (FPGA) When the type specifying section 41 is realized by the PLD, the storing section 44 can function as a memory element such as a memory block included in a part of a logical block configuring the PLD. The PLD may have a configuration in which software processing and hardware processing are mixed.

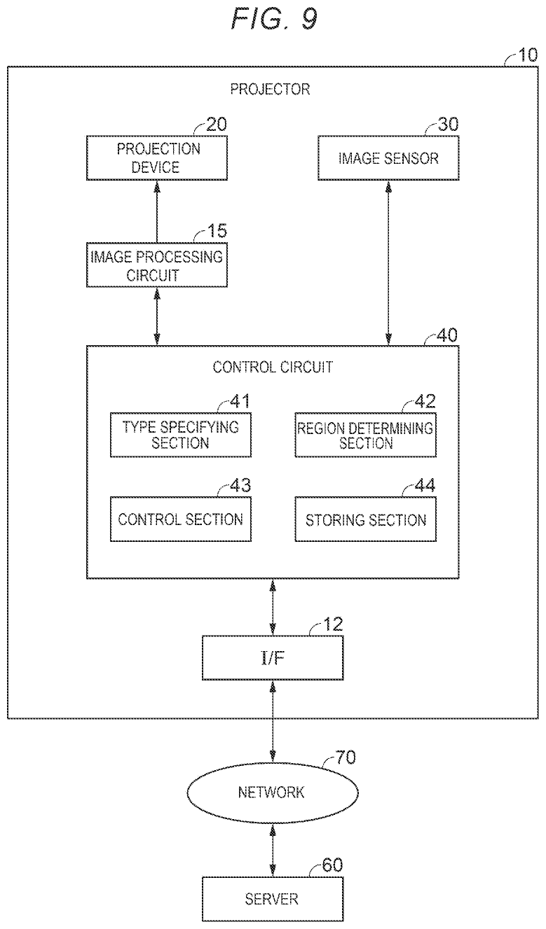

For example, as shown in FIG. 9, the I/F 12 establishes a communication link between the I/F 12 and an external server 60 via a network 10 such as the Internet and acquires information for updating the learned model of the type specifying section 41. The control circuit 40 updates the learned model of the type specifying section 41 with the information acquired from the server 60 via the network 70. Consequently, the type specifying section 41 is capable of, for example, changing the learned model according to a use and using the latest learned model. The control section 43 may change, according to a type of the object Q, a degree of reducing the luminance of the image P.

Besides, it goes without saying that the present disclosure includes various embodiments not described above such as a configuration in which the components described above are applied to one another. The technical scope of the present disclosure is decided only by the matters to define the invention relating the claims reasonable from the above explanation.

What is claimed is:

1. A control method for a projector, comprising:
projecting an image onto a projection surface;
acquiring image data from an image sensor having a visual field including the image;
specifying, based on the image data, a type of an object included in the visual field;
determining, according to the type, a region where the object overlaps the image in the image data; and
selectively reducing luminance of the image in a range corresponding to the region.

2. The control method for the projector according to claim 1, wherein the visual field is wider than the image.

3. The control method for the projector according to claim 1, wherein the type of the object is specified using a learned model generated by machine learning.

4. The control method for the projector according to claim 3, wherein the learned model is updated by information acquire from an outside via a network.

5. The control method for the projector according to claim 1, wherein, in the image data, a type of the object present outside the image is specified and the object is tracked.

6. A projector comprising:
a projection device configured to project an image onto a projection surface;
an image sensor having a visual field including the image;
a type specifying section configured to specify, based on image data acquired from the image sensor, a type of an object included in the visual field;
a region determining section configured to determine, according to the type, a region where the object overlaps the image in the image data; and
a control section configured to control the projection device to selectively reduce luminance of the image in a range corresponding to the region.
